(19) United States
(12) Patent Application Publication
(10) Pub. No.: US 2026/0155638 A1
(43) Pub. Date: Jun. 4, 2026

(54) PLOW CHUTE SYSTEM

(71) Applicant: Black & Veatch Corporation, Overland Park, KS (US)

(72) Inventors: Donald Waters, Overland Park, KS (US); Schalk Van Der Merwe, Overland Park, KS (US)

(21) Appl. No.: 19/389,209

(22) Filed: Nov. 14, 2025

Related U.S. Application Data
(60) Provisional application No. 63/720,815, filed on Nov. 15, 2024.
(60) Provisional application No. 63/828,356, filed on Jun. 23, 2025.

(51) Int. Cl. H02G 1/06

(52) U.S. Cl. CPC H02G 1/06

(57) ABSTRACT

A system for laying a plurality of cables into a trench. The system includes an upper section and a lower section. The upper section includes a first set of guides configured to direct the plurality of cables downward into the trench. The lower section includes a second set of guides configured to redirect the cables substantially horizontally in the trench. Each of the first set of guides and the second set of guides includes a left guide and a right guide to retain at least some of the plurality of cables in at least one pairing.

### RELATED APPLICATIONS

This non-provisional utility patent application claims priority benefit, with regard to all common subject matter, of U.S. Provisional Patent Application Ser. No. 63/720,815, titled “PLOW CHUTE SYSTEM”, filed Nov. 15, 2024, and U.S. Provisional Patent Application Ser. No. 63/828,356, titled “PLOW CHUTE SYSTEM, filed Jun. 23, 2025. Application Ser. No. 63/720,815 and Application Ser. No. 63/828,356 are hereby incorporated by reference, in their entireties, into the present patent application.

### BACKGROUND

Embodiments of the present invention solve the above-mentioned problems and provide a distinct advance in the art of plow chutes for burying cables in trenches. More particularly, the present invention provides a plow chute system that pairs DC cables together as the plow chute system guides the DC cables into the trench.

Cables for Alternating Current (AC) circuits are often buried in trenches via plow chutes attached to trench-forming plows. In this way, the cables are automatically laid as the trenches are formed. Unfortunately, the plow chutes can only lay cables in a tri-plex configuration. Cables for Direct Current (DC) circuits (and in particular multiple DC circuits) must be laid by hand.

This background discussion is intended to provide information related to the present invention which is not necessarily prior art.

### SUMMARY

Embodiments of the present invention solve the above-mentioned problems and provide a distinct advance in the art of plow chutes for burying cables in trenches. More particularly, the present invention provides a plow chute system that pairs DC cables together as the plow chute system guides the DC cables into the trench.

An embodiment of the present invention is a system for laying a number of cables into a trench. The system includes an upper section and a lower section. The upper section includes a first set of guides configured to direct the cables downward into the trench. The lower section includes a second set of guides configured to redirect the cables substantially horizontally in the trench. The first set of guides and the second set of guides each include a left guide and a right guide to retain at least some of the cables in at least one pairing.

In another embodiment, the second set of guides (of the lower section) further includes a warning tape guide, a ground cable guide, a power cable guide, and a control cable guide. The first set of guides (of the upper section) may also include one or more of a warning tape guide, a ground cable guide, a power cable guide, and a control cable guide.

Another embodiment is a system for laying a number of cables into a trench. The system includes an upper section and a lower section. The upper section includes a first set of tubular conduits configured to direct the cables downward into the trench. The lower section includes a second set of tubular conduits, a depth shaft, a lateral shaft, a depth gauge, and a depth wheel. The second set of tubular conduits are configured to redirect the cables substantially horizontally in the trench. The depth shaft extends vertically downward relative to the second set of tubular conduits. The lateral shaft is configured to space the depth shaft horizontally from the second set of tubular conduits. The depth gauge is attached to the depth shaft and is configured to indicate whether the cables are being laid in the trench at a desired depth. The depth wheel is attached to a lower end of the depth shaft for engaging a ground surface near the trench. Each of the first set of tubular conduits and the second set of tubular conduits include at least five left tubular conduits and at least five right tubular conduits to retain at least some of the cables in at least five pairings. The second set of tubular conduits further includes a warning tape conduit, a ground cable conduit, a power cable conduit, and a control cable conduit.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### DRAWINGS

Embodiments of the present invention are described in detail below with reference to the attached drawing figures, wherein:

FIG. 1 is an environmental view of a plow chute constructed in accordance with an embodiment of the invention;

FIG. 2 is an environmental view of an upper section of the plow chute of FIG. 1;

FIG. 3A is a perspective view of components of the upper section;

FIG. 3B is an elevation view of the components of FIG. 3A;

FIG. 4A is an elevation view of components of the upper section in accordance with an embodiment of the invention;

FIG. 4B is a side view the components of FIG. 4A

FIG. 4C is a perspective view of the components of FIG. 4A;

FIG. 5A is a plan view of components of a lower section of the plow chute of FIG. 1;

FIG. 5B is a side elevation view of the components of FIG. 5A;

FIG. 5C is a front elevation view of the components of FIG. 5A;

FIG. 5D is a perspective view of the components of FIG. 5A;

FIG. 6 is an environmental view of the lower section;

FIG. 7 is an environmental view of the lower section;

FIG. 8 is an enlarged view of certain components of the upper section;

FIG. 9A is a side elevation view of a lower section constructed in accordance with another embodiment of the invention;

FIG. 9B is a plan view of the lower section of FIG. 9A;

FIG. 9C is a side elevation view of certain components of the lower section of FIG. 9A;

FIG. 10A is a side elevation view of certain components of the lower section of FIG. 9A;

FIG. 10B is plan view of certain components of the lower section of FIG. 9A;

FIG. 10C is a side elevation view of certain components of the lower section of FIG. 9A; and

FIG. 10D is a side elevation view of certain components of the lower section of FIG. 9A.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

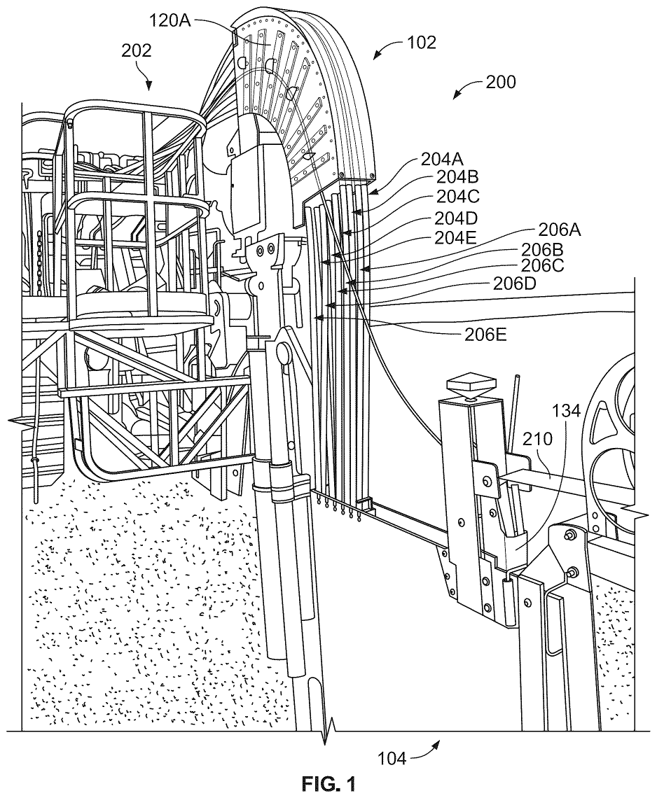

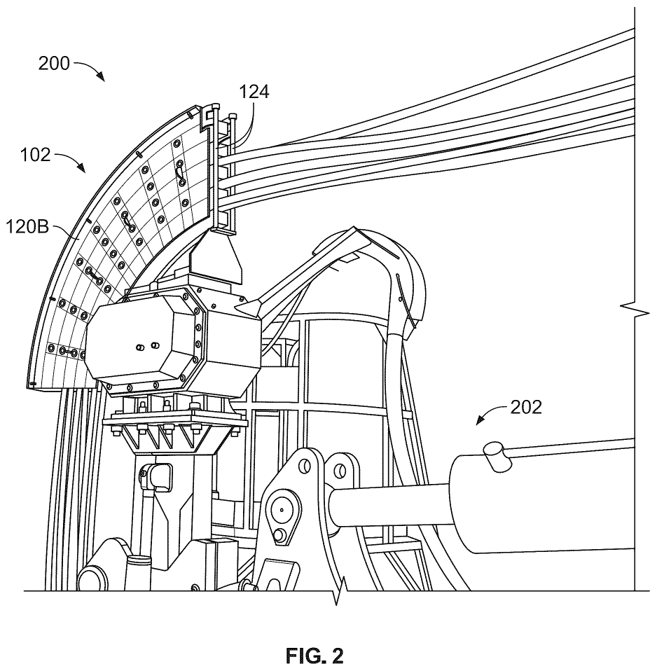

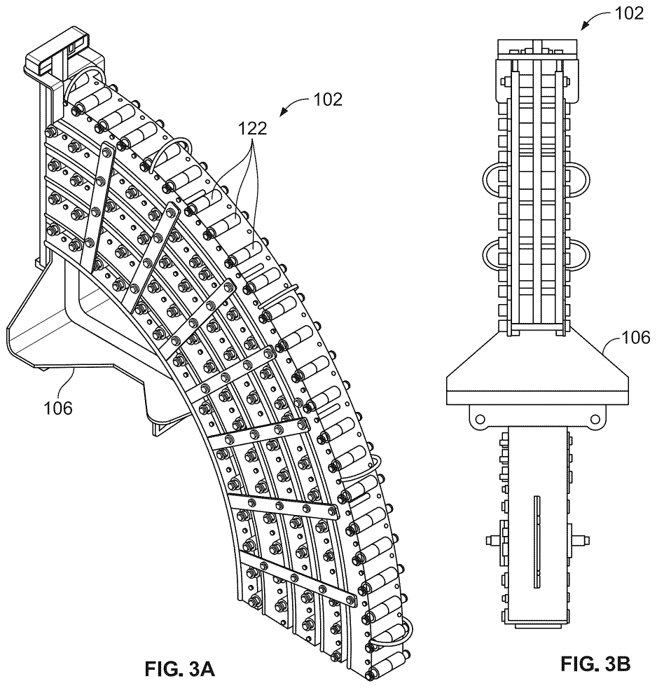

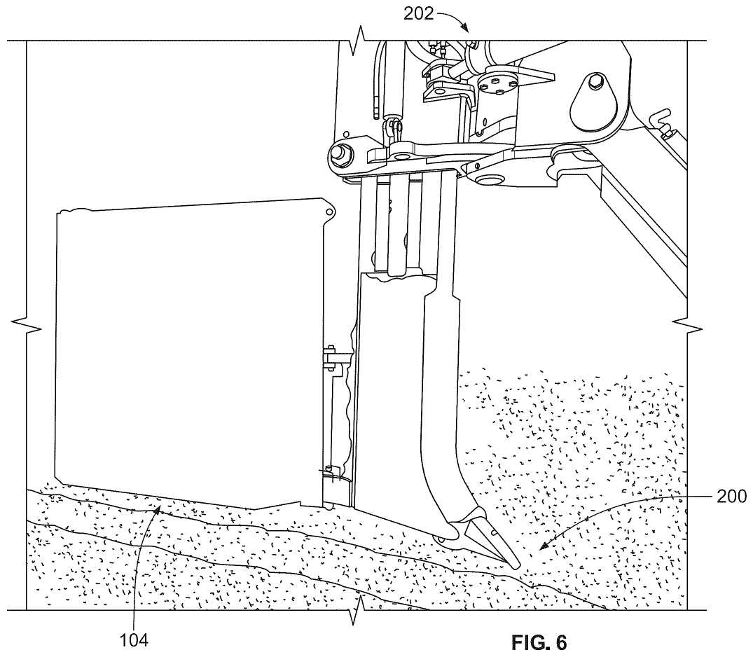

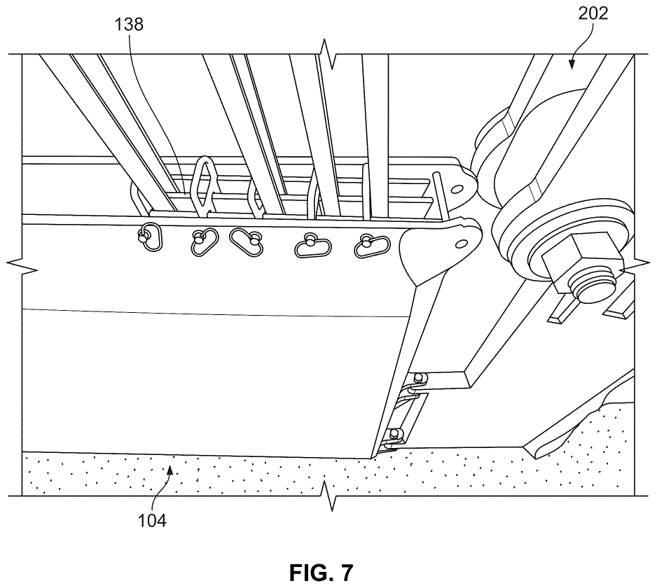

Turning to FIGS. 1-7, the present invention provides a plow chute system 100 for laying DC cables into a trench 200 formed via a plow 202. The plow chute system 100 allows positive DC cables 204A-E, corresponding negative DC cables 206A-E, a ground cable, and warning tape 210 to be laid into the trench 200. The plow chute system 100 broadly comprises an upper section 102 for directing the cables 204A-E, 206A-E, into the trench 200 and a lower section 104 for positioning the cables 204A-E, 206A-E, the ground cable, and warning tape 210 in the trench 200.

The cables 204A-E, 206A-E and the ground cable may be insulated aluminum, copper, or any other suitable conductor cable. For example, the cables 204A-E, 206A-E may be photovoltaic aluminum cables provided in the specification sheet below.

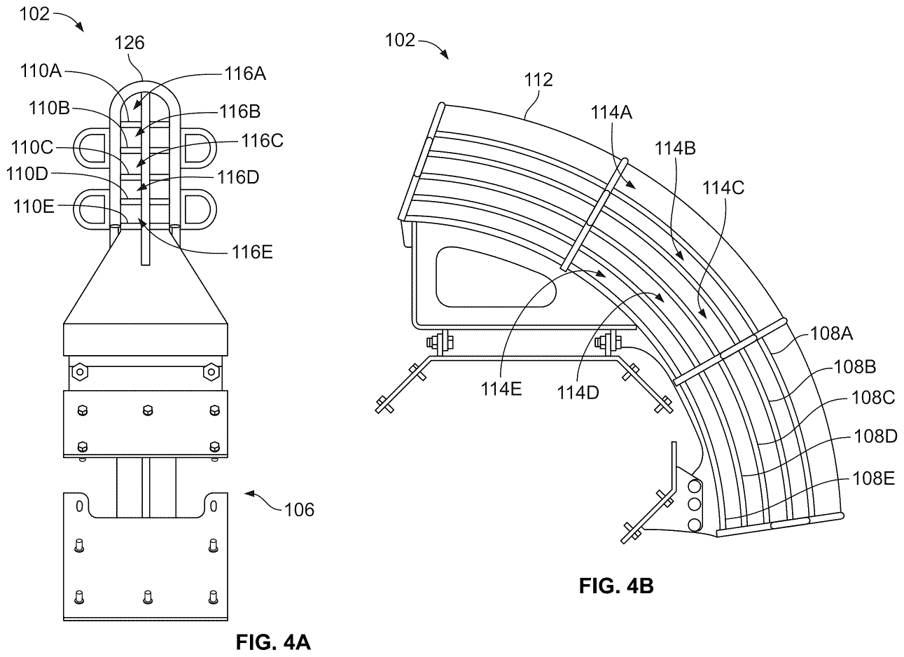

As best seen in FIGS. 1-4C, the upper section 102 broadly comprises mounting structure 106, a plurality of left guides 108A-E and right guides 110A-E and a divider 112 cooperatively forming left guide channels 114A-E and right guide channels 116A-E, a plurality of connectors 118, a plurality of sidewalls 120 a plurality of rollers 122, and left and right lateral guide rollers 124. In one embodiment, the upper section 102 also includes a plurality of braces 126 instead of or in addition to the connectors 118, as seen in FIGS. 4A-C.

The mounting structure 106 supports the upper section 102 on an upper end of the plow 202 and may include ribs, reinforcements, gussets, and the like for withstanding bending moments, twisting, shear forces, and the like. The mounting structure 106 may also include fastener holes for receiving fasteners therethrough.

The left guides 108A-E may be arcuate dividers radially spaced from each other in an expanding arc on a left side of the divider 112. Similarly, the right guides 110A-E may be arcuate dividers radially spaced from each other in an expanding arc on a right side of the divider 112 such that each one of the right guides 110A-E laterally pairs with one of the left guides 108A-E.

The divider 112 partitions the left guides 108A-E from the right guides 110A-E. The divider 112 may be a plate or similar structure or structures extending along a vertical plane.

Each of the left guide channels 114A-E receives one cable of one set of cables (e.g., positive cables 204A-E). For example, left guide channel 114A may receive positive cable 204A. The left guide channels 114A-E may be formed by left guides 108A-E, the divider 112, and the left connectors 118A, the left sidewall 120A, and/or left portions of the braces 126.

Each of the right guide channels 116A-E receives one cable of the other set of cables (e.g., negative cables 206A-E). For example, right guide channel 116A may receive negative cable 206A. In this way, positive cable 204A and negative cable 206A are paired together on opposite sides of the divider 112. The right guide channels 116A-E may be formed by right guides 110A-E, the divider 112, and the right connectors 118B, the right sidewall 120B, and/or right portions of the braces 126.

The connectors 118 (FIG. 8) extend between the left guides 108A-E or right guides 110A-E and provide rigidity to the upper section 102, specifically resisting bending moments, twisting, shear forces. The connectors 118 also at least partially define the left and right guide channels 114A-E, 116A-E as discussed above.

The sidewalls 120A, B at least partially enclose the left and right guide channels 114A-E, 116A-E. The sidewalls 120A, B may provide additional structural rigidity to the upper section 102, prevent dirt and debris from entering the left and right guide channels 114A-E, 116A-E, and protect the cables 204A-E, 206A-E.

The rollers 122 extend laterally in or near the left guide channels 114A-E and right guide channels 116A-E and are spaced apart from each other in the left guide channels 114A-E and right guide channels 116A-E. The rollers 122 may be configured to rotate from contact with the cables 204A-E, 206A-E to reduce friction of the cables as they pass through the left guide channels 114A-E and right guide channels 116A-E.

The left and right lateral guide rollers 124 extend vertically near openings of the left guide channels 114A-E and right guide channels 116A-E and are spaced laterally apart from each other. The left and right lateral guide rollers 124 may be configured to rotate from contact with the cables 204A-E, 206A-E and prevent chafing and other damage to the cables as they enter the left guide channels 114A-E and right guide channels 116A-E.

The braces 126 (FIGS. 4A-C) may be inverted U-shaped rods extending between the left guides 108A-E or right guides 110A-E and may provide rigidity to the upper section 102, specifically resisting bending moments, twisting, shear forces. The braces 126 may also at least partially define the left and right guide channels 114A-E, 116A-E. The braces 126 may be used in addition to or alternative to the connectors 118 described above.

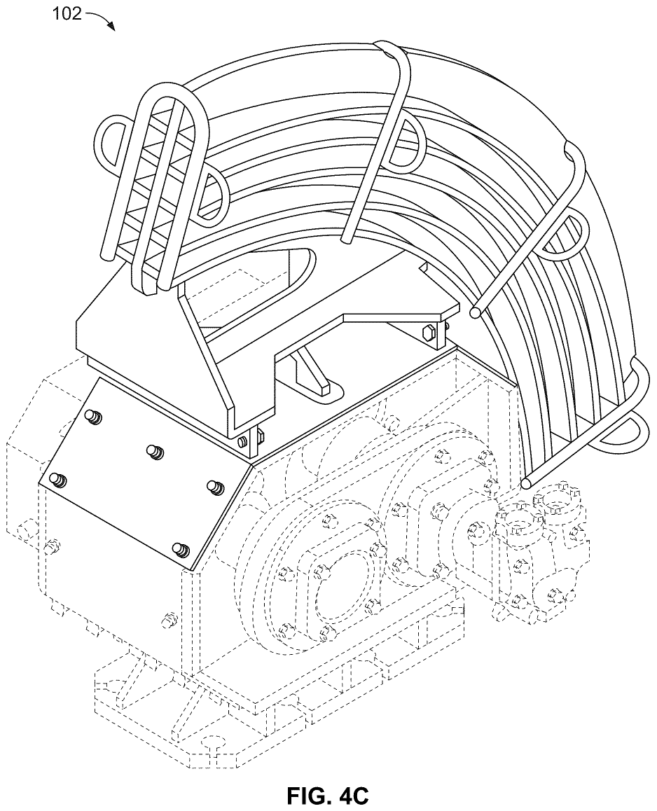

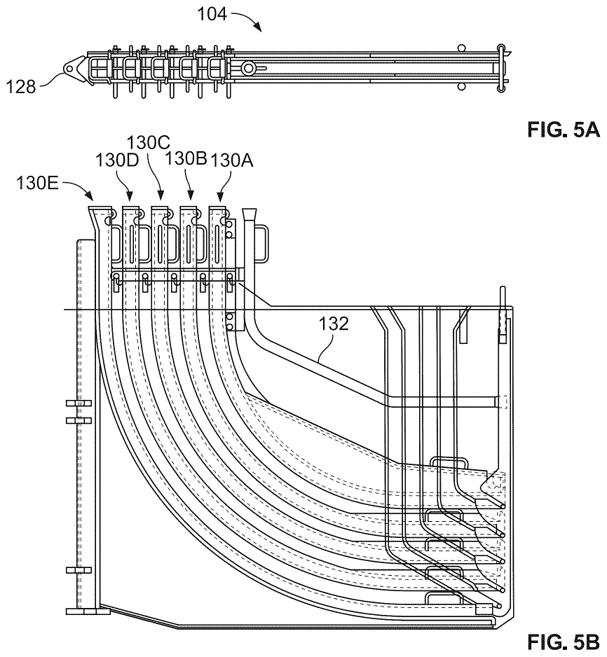

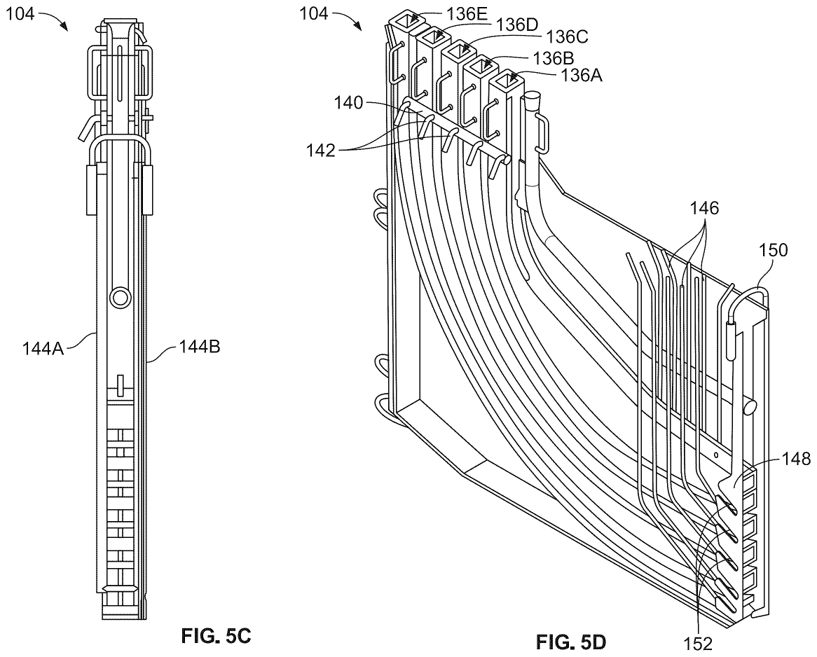

Turning to FIGS. 5A-7, the lower section 104 broadly comprises a mounting structure 128, a plurality of conduits 130A-E, a ground cable conduit 132, a warning tape conduit 134, a plurality of conduit channels 136A-G, a plurality of conduit guides 138A-E, a conduit securing member 140, a plurality of quick access pins 142, left and right sidewalls 144A, B, a plurality of guide rails 146, a conduit bracket 148, and a brace 150.

The mounting structure 128 supports the lower section 104 on a lower end of the plow 202 and may be in the form of a hinge for allowing the lower section 104 to pivot relative to the plow 202. To that end, the mounting structure 128 may include fastener holes for receiving hinge pins therethrough.

Each conduit 130A-E may be an arcuate tube or similar structure radially stacked in an expanding arc (i.e., nested together) with the other conduits. The conduits 130A-E may be open-ended and may form the conduit channels 136A-E for receiving the cables 204A-E, 206A-E therethrough. The conduits 130A-E may be secured in place via the conduit securing member 140, and the conduit bracket 148.

The ground cable conduit 132 may be similar to the conduits 130A-E described above except the ground cable conduit 132 only receives a ground cable. The ground cable conduit 132 may be nested adjacent to the conduit 130A.

The warning tape conduit 134 may be similar to the conduits 130A-E described above or may be more cylindrical than the conduits 130A-E. The warning tape conduit 134 receives the warning tape 210 therethrough. The warning tape conduit 134 may be somewhat spaced from the ground cable conduit 132A so that an aft opening of the warning tape conduit 134 is spaced above an aft opening of the ground cable conduit 132.

The conduit channels 136A-G receive the cables 204A-E, 206A-E, ground cable, and the warning tape 210. Other than the conduit guides 138A-E, the conduit channels 136A-E may not separate the cables 206A-E from the corresponding cables 204A-E.

The conduit guides 138A-E may be positioned near intake openings of the conduit channels 136A-E. The conduit guides 138A-E may divide the cables 206A-E from corresponding cables 204A-E as they enter the conduits 130A-E to ensure the cables 204A-E, 206A-E remain oriented correctly.

The conduit securing member 140 may be positioned near an upper end of the lower section 104 for retaining the conduits 130A-E in the lower section 104. The conduit securing member 140 may include openings for receiving the quick access pins 142.

The quick access pins 142 may be removably positioned in the conduit securing member 140. The quick access pins 142 allow a user to remove the conduit securing member 140 and gain access to the conduits 130A-E.

The sidewalls 144A, B at least partially enclose the conduits 130A-E, ground cable conduit 132, and warning tape conduit 134. The sidewalls 144A, B may provide additional structural rigidity to the lower section 104 and prevent damage to the conduits 130A-E, ground cable conduit 132, and warning tape conduit 134.

The guide rails 146 may ensure proper positioning of the conduits 130A-E and the ground cable conduit 132. To that end, the guide rails 146 may be elongated rods extending vertically downward and diagonally downward with a bends between vertical and diagonal portions.

The conduit bracket 148 may be positioned near an aft end of the lower section 104. The conduit bracket 148 may include slots 152 for retaining ends of the conduits 130A-E.

The brace 150 may extend between the sidewalls 144 for retaining a width therebetween. The brace 150 may be an inverted U-shaped rod welded to the sidewalls 144.

Use of the plow chute system 100 will now be described in more detail. First, the upper section 102 and the lower section 104 may be mounted to the plow 202 such that the left and right guides 108A-E, 110A-E of the upper section 102 align with the conduits 130A-E of the lower section 104. Positive and negative DC cables 204A-E, 206A-E may then be fed through the left guide channels 114A-E and right guide channels 116A-E and then through the conduits 130A-E. The ground cable may also be fed through the ground cable conduit 132 of the lower section 104. Similarly, the warning tape 210 may be fed through the warning tape conduit 134.

The plow 202 may then be pulled along the ground to form trench 200. The cables 204A-E, 206A-E are thereby drawn through the left and right guide channels 114A-E, 116A-E and down through the conduits 130 so that they are laid in the trench 200 in positive and negative pairs vertically spaced above each other, thus forming up to five individual DC circuits. The ground cable is also drawn down through the ground cable conduit 132 such that the ground cable is spaced above the cables 204A-E, 206A-E in the trench 200. Similarly, the warning tape 210 is drawn down through the warning tape conduit 134 such that the warning tape 210 is spaced above the ground cable in the trench 200.

A depth of the cables can be adjusted hydraulically via the plow 202. Cable depths may be dictated by specification or owner's requirement and can be adjusted to meet those specifications. The warning tape 210 may be installed according to specification or owner's requirements. The plow chute 100 may be adjusted to meet those specifications. The plow chute 100 may accommodate cables up to 750MCM or 1000 MCM.

The present invention provides several advantages. For example, the plow chute 100 enables up to five separate DC circuits to be laid automatically simultaneously. The plow chute 100 also eliminates the need to excavate trenches and lay cable by hand. The plow chute 100 also eliminates the need to place sand bedding in trenches followed by backfill and compaction, which is very time consuming.

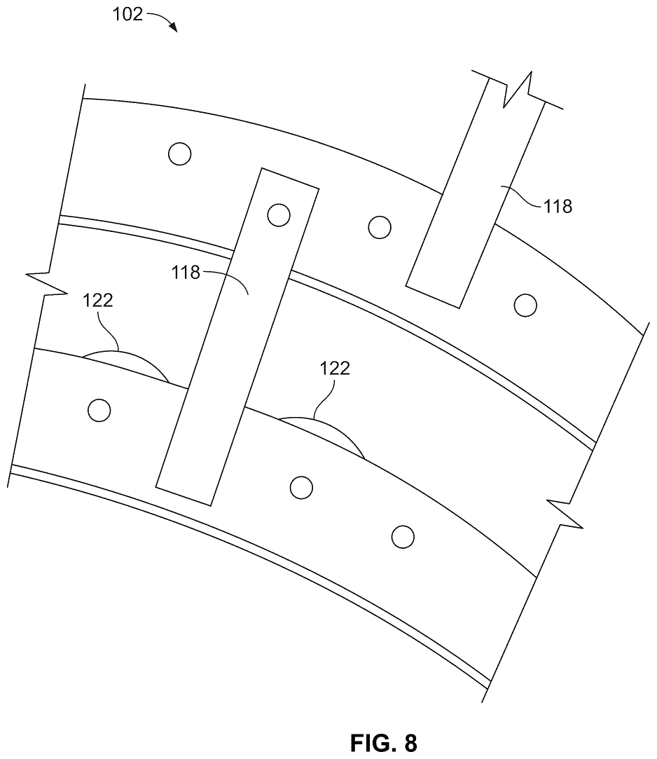

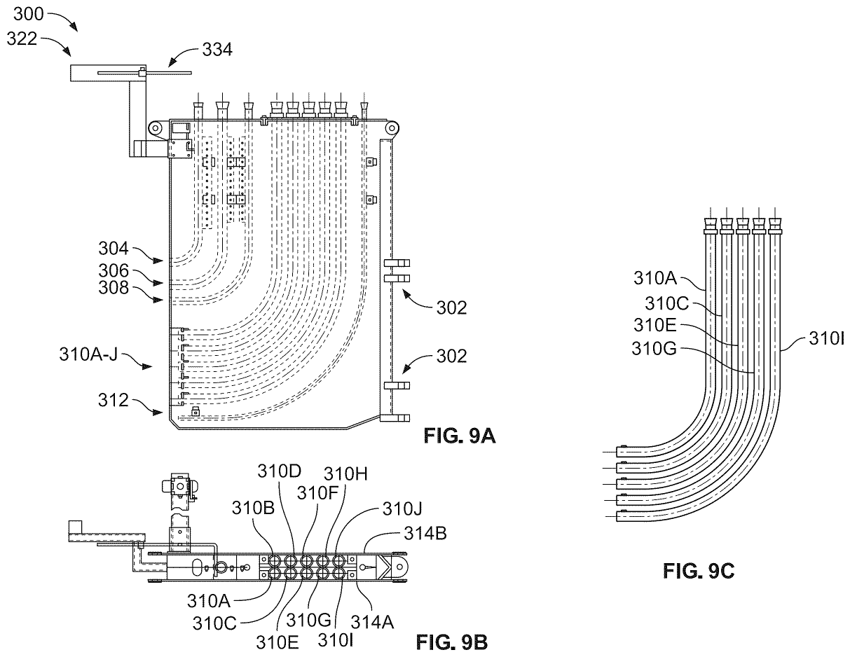

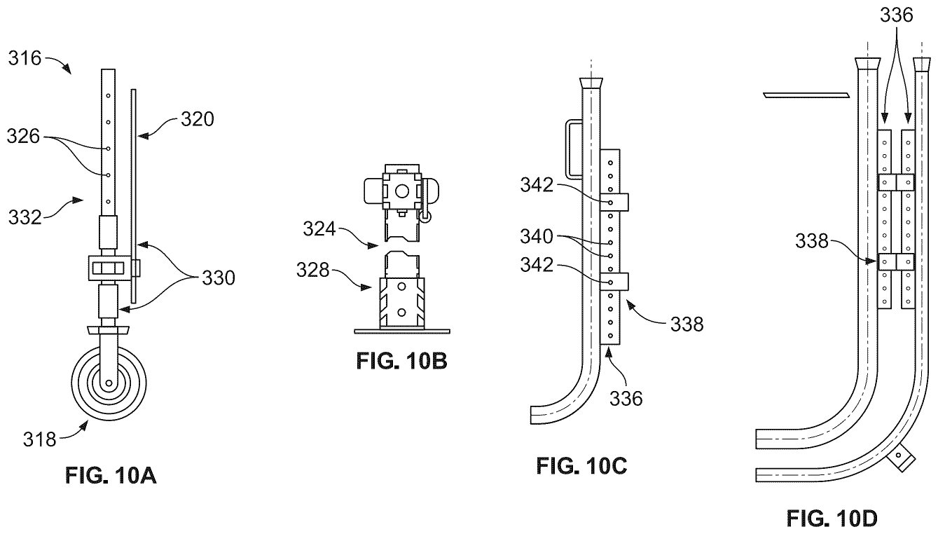

Turning to FIGS. 9A-10D, a lower section 300 of a plow chute system constructed in accordance with another embodiment of the invention will now be described. The lower section 300 broadly comprises a mounting structure 302, a warning tape conduit 304, a ground cable conduit 306, a control cable conduit 308, a plurality of DC cable conduits 310A-J, a power cable conduit 312, left and right sidewalls 314A, B, a depth shaft 316, a depth wheel 318, a depth gauge 320, and a tape reel support 322.

The mounting structure 302 supports the lower section 300 on a lower end of the plow 202 and may be in the form of a hinge for allowing the lower section 300 to pivot relative to the plow 202. To that end, the mounting structure 302 may include fastener holes for receiving hinge pins therethrough.

The warning tape conduit 304 may be similar to the conduits described below or may have a different shape to accommodate a shape of the warning tape. The warning tape conduit 304 receives the warning tape 304 therethrough and may be somewhat spaced from the ground cable conduit 306 so that an aft opening of the warning tape conduit 304 is spaced above an aft opening of the ground cable conduit 306.

The ground cable conduit 306 may be similar to the other conduits described herein except the ground cable conduit 306 only receives a ground cable. The ground cable conduit 306 may be nested adjacent to the conduit warning tape conduit 304. The ground cable conduit 306 may be somewhat spaced from the warning tape conduit 304 and the control cable conduit 308.

The control cable conduit 308 may be similar to the other conduits described herein except the control cable conduit 308 only receives a control cable. The control cable conduit 308 may be nested adjacent to the ground cable conduit 306. The control cable conduit 308 may be somewhat spaced from the ground cable conduit 306 and the DC cable conduits 310A-J.

Each of the DC cable conduits 310A-J may be an arcuate tube or similar structure radially stacked in an expanding arc (i.e., nested together) with the other conduits. The conduits 310A-J may be paired (e.g., 310A, B; 310C, D; 310E, F; 310G, H; 310I, J) for receiving pairs of DC cables. This embodiment includes five pairs of DC cable conduits for accommodating five pairs of DC cables, but additional conduit pairs could be used to accommodate more pairs of DC cables. To accommodate additional pairs, some of the additional pairs could be laterally adjacent previous pairs. For example, for ten pairs of DC cable conduits (accommodating ten pairs of DC cables), two pairs of DC cable conduits could be positioned in each nested “layer”.

The power cable conduit 312 may be similar to the other conduits described herein except the power cable conduit 312 only receives a power cable. The power cable conduit 312 may be nested adjacent to the DC cable conduits 310A-J. The power cable conduit 312 may be somewhat spaced from the DC cable conduits 310A-J.

The left and right sidewalls 314A, B at least partially enclose the warning tape conduit 304, the ground cable conduit 306, the control cable conduit 308, the DC cable conduits 310A-E, and the power cable conduit 312. The left and right sidewalls 314A, B may provide additional structural rigidity to the lower section 300 and prevent damage to the aforementioned conduits.

The depth shaft 316 extends downward from the lower section 300 and may be attached thereto via a lateral shaft 324. The depth shaft 316 may be adjustable relative to the lateral shaft 324 for accommodating trenches of different depth. The depth shaft 316 supports the depth wheel 318 at a distal end thereof. The depth shaft 316 may be tube steel or similar material and may include positioning holes 326 for securing the depth shaft 316 at one of a number of vertical positions representing different depths. The depth shaft 316 may include markings (e.g., tape, paint, or the like) between which a tip of the depth gauge should remain indicating the cables are being laid at a proper depth.

The lateral shaft 324 may be adjustable for laterally spacing the depth shaft 316 from the trench. This may be useful for accommodating trenches of different widths. The lateral shaft 324 may be tube steel or similar material. The lateral shaft 324 may include positioning holes 328 for securing the lateral shaft 316 at one of a number of lateral positions.

The depth wheel 318 may extend downward from the depth shaft 316 for rolling along the ground surface near the trench. The depth wheel 318 may be a caster wheel for passively following the lower section 300. The depth wheel 318 may be configured to move up and down relative to the depth shaft 316 (or the rest of the lower section 300). The depth wheel 318 may be connected to the depth gauge 320 so that the depth gauge 320 moves up and down with the depth wheel 318.

The depth gauge 320 may be a rod configured to move up and down with the depth wheel 318. The depth gauge 320 may be positioned so that a distal end thereof may move near or between the markings of the depth shaft 316 to indicate whether the cables are being laid at a proper depth.

The depth gauge 320 may be bracketed by bracketing springs 330, which may in turn be secured on the depth shaft 316 via washer 332. The bracketing springs 330 may also ensure smooth vertical movement of the depth wheel 318 while limiting upward travel thereof.

The tape reel support 322 may extend in-line with and above the warning tape conduit 304 for feeding warning tape thereto. To that end, the tape reel support 322 may be formed of tube steel or similar material. The tape reel support 322 may include a tape support bar 334 extending therefrom for guiding the warning tape into the warning tape conduit 304.

At least the warning tape conduit 304, the ground cable conduit 306, and the control cable conduit 308, may be vertically adjustable to set tape or cable depth according to desired or required spacing or depths. To that end, the tape conduit 304, the ground cable conduit 306, and/or the control cable conduit 308 may include adjustment flanges 336, which may be connected to each other via adjustment plates 338.

The adjustment flanges 336 may be vertically-extending bars or plates including spaced apart adjustment holes 340. The adjustment flanges 336 may be positioned near adjustment flanges 336 of adjacent conduits for connecting adjustment plates 338 therebetween.

Each adjustment plate 338 may include a pair of adjustment holes 342 configured to be aligned with some of the adjustment holes 340. Fasteners may then be inserted through the aligned adjustment holes 340, 342, thereby setting the depth of adjacent conduits and securing the adjacent conduits together.

The above-described lower section 300 provides several advantages. For example, the conduits 310A-J accommodate five pairs of DC cables. The conduits allow for a horizontally shorter device, which improves maneuverability and ease of use. The depth gauge 320 ensures cables are being buried to a desired depth. The adjustment flanges 336 and adjustment plates 338 allow for adjustable depth and spacing between the cables.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for laying a plurality of cables into a trench, the system comprising:
an upper section including a first plurality of guides configured to direct the plurality of cables downward into the trench; and
a lower section including a second plurality of guides configured to redirect the plurality of cables substantially horizontally in the trench,
each of the first plurality of guides and the second plurality of guides including a left guide and a right guide to retain at least some of the plurality of cables in at least one pairing.

2. The system of claim 1, wherein the plurality of cables include direct current (DC) cables, such that one of the cables in the at least one pairing is a positive DC cable and the other one of the cables in the at least one pairing is a negative DC cable.

3. The system of claim 1, wherein each of the first plurality of guides and the second plurality of guides includes five left guides and five right guides to retain the at least some of the plurality of cables in at least five pairings.

4. The system of claim 3, wherein the upper section and the lower section each includes a divider delineating the left guides from the right guides.

5. The system of claim 1, wherein the first plurality of guides and the second plurality of guides are arcuate.

6. The system of claim 1, wherein the first plurality of guides are nested relative to each other and the second plurality of guides are nested relative to each other.

7. The system of claim 1, wherein each of the upper section and the lower section includes sidewalls with the first plurality of guides and the second plurality of guides being positioned between the sidewalls.

8. The system of claim 1, wherein one of the plurality of cables is a ground cable and one of the first plurality of guides and one of the second plurality of guides is a ground cable guide for laying the ground cable in the trench.

9. The system of claim 1, wherein one of the plurality of cables is a power cable and one of the first plurality of guides and one of the second plurality of guides is a power cable guide for laying the power cable in the trench.

10. The system of claim 1, wherein one of the first plurality of guides and one of the second plurality of guides is a warning tape guide for laying a warning tape in the trench above the plurality of cables.

11. The system of claim 1, wherein the first plurality of guides and the second plurality of guides are tubular conduits.

12. The system of claim 1, wherein the lower section further includes a depth shaft and a depth gauge attached to the depth shaft, the depth gauge being configured to indicate whether the cables are being laid in the trench at a desired depth.

13. The system of claim 12, wherein the lower section further includes a depth wheel attached to a lower end of the depth shaft.

14. The system of claim 13, wherein the lower section further includes a plurality of bracketing springs connected to the depth shaft and configured to ensure smooth vertical movement of the depth wheel.

15. The system of claim 12, further comprising a lateral shaft configured to space the depth shaft horizontally from the second plurality of guides.

16. A system for laying a warning tape and a plurality of cables including at least two DC cables, a ground cable, a power cable, and a control cable into a trench, the system comprising:
an upper section including a first plurality of guides configured to direct the plurality of cables downward into the trench; and
a lower section including a second plurality of guides configured to redirect the plurality of cables substantially horizontally in the trench, the second plurality of guides including:
a warning tape guide configured to direct the warning tape into the trench;
a ground cable guide configured to direct the ground cable into the trench;
a power cable guide configured to direct the power cable into the trench; and
a control cable guide configured to direct the control cable into the trench, each of the first plurality of guides and the second plurality of guides including a left guide and a right guide configured to retain the at least two DC cables in at least one pairing as the first plurality of guides and the second plurality of guides direct the at least two DC cables into the trench.

17. The system of claim 16, wherein the lower section further includes a depth shaft and a depth gauge attached to the depth shaft, the depth gauge being configured to indicate whether the cables are being laid in the trench at a desired depth.

18. The system of claim 16, wherein the at least two DC cables includes ten DC cables, and each of the first plurality of guides and the second plurality of guides includes five left guides and five right guides to retain the ten DC cables in five pairings.

19. A system for laying a warning tape and a plurality of cables including at least ten DC cables, a ground cable, a power cable, and a control cable into a trench, the system comprising:
an upper section including a first plurality of tubular conduits configured to direct the plurality of cables downward into the trench;
a lower section including:
a second plurality of tubular conduits configured to redirect the plurality of cables substantially horizontally in the trench, the second plurality of cables including:
a warning tape conduit configured to direct the warning tape into the trench;
a ground cable conduit configured to direct the ground cable into the trench;
a power cable conduit configured to direct the power cable into the trench; and
a control cable conduit configured to direct the control cable into the trench;
a depth shaft extending vertically downward relative to the second plurality of tubular conduits;
a lateral shaft configured to space the depth shaft horizontally from the second plurality of tubular conduits;
a depth gauge attached to the depth shaft and configured to indicate whether the cables are being laid in the trench at a desired depth; and
a depth wheel attached to a lower end of the depth shaft for engaging a ground surface near the trench;
each of the first plurality of tubular conduits and the second plurality of tubular conduits including at least five left tubular conduits and at least five right tubular conduits to retain the at least ten DC cables in at least five pairings.

20. A method of laying cables in a trench, the method comprising steps of:
pairing DC cables together via left and right guides of an upper section of a cable laying system;
directing the paired DC cables downward into the trench via the left and right guides of the upper section;
retaining the paired DC cables together via left and right guides of a lower section of the cable laying system; and
directing the paired DC cables horizontally in the trench via the left and right guides.
